(19) United States
(12) Patent Application Publication
(10) Pub. No.: US 2010/0086810 A1
(43) Pub. Date: Apr. 8, 2010

(54) FUEL CELL ASSEMBLY

(76) Inventors: Peter David Hood, Leicester (GB); Muralidharan Arikara, Folsom, CA (US)

Correspondence Address: Luce, Forward, Hamilton & Scripps LLP, 2050 Main Street, Suite 600, Irvine, CA, 92614, US

(21) Appl. No.: 12/393,991

(22) Filed: Feb. 26, 2009

(30) Foreign Application Priority Data
Oct. 7, 2008 (GB) 0818320.4

(51) Int. Cl. H01M 8/04

(52) U.S. Cl. 429/13; 429/26

(57) ABSTRACT

A fuel cell assembly (100) comprising: an enclosure (120) for mounting a fuel cell stack (110) therein, the enclosure comprising an air flow path (160) extending between an air inlet (180) and an air outlet (190); and a fuel cell stack (110) having a plurality of cathode air coolant paths extending between a first face (111) and an opposing second face (112) of the stack, wherein the fuel cell stack is mounted within the enclosure to provide a first tapering air volume (140) between the first face of the stack and a first side wall (121) of the enclosure and a second tapering air volume (150) between the second face of the stack and a second opposing side wall (122) of the enclosure.

### RELATED APPLICATION

This application claims the benefit of and priority to United Kingdom Application Serial No. 0818320.4, filed Oct. 7, 2008, the contents of which are incorporated by reference herein in its entirety.

### BACKGROUND

1. Field

The present disclosure relates to fuel cell assemblies, in particular to enclosures for mounting open cathode fuel cell stacks.

2. General Background

Conventional electrochemical fuel cells convert fuel and oxidant, generally both in the form of gaseous streams, into electrical energy and a reaction product. A common type of electrochemical fuel cell for reacting hydrogen and oxygen comprises a polymeric ion (proton) transfer membrane, with fuel and air being passed over each side of the membrane. Protons (i.e. hydrogen ions) are conducted through the membrane, balanced by electrons conducted through a circuit connecting the anode and cathode of the fuel cell. To increase the available voltage, a stack may be formed comprising a number of such membranes arranged with separate anode and cathode fluid flow paths. Such a stack is typically in the form of a block comprising numerous individual fuel cell plates held together by end plates at either end of the stack.

Because the reaction of fuel and oxidant generates heat as well as electrical power, a fuel cell stack requires cooling once an operating temperature has been reached. Cooling may be achieved by forcing air through the cathode fluid flow paths. In an open cathode stack, the oxidant flow path and the coolant path are the same, i.e. forcing air through the stack both supplies oxidant to the cathodes and cools the stack.

In order to integrate a fuel cell stack with other equipment for the stack to provide power to, the stack may be provided as an integrated assembly, having integrated air and fuel lines and electrical outlet connections. The assembly requires coolant paths, which may be the same or different to the oxidant flow paths, typically provided by manifolds leading to and from the stack. Particular care needs to be taken on how the air flow interfaces with the cathode flow paths, so that a uniform air flow and minimal pressure drop is achieved. Designing such manifolds can lead to increased complexity and cost of the operational unit.

A further complication is the need to design a different fuel cell assembly for each different application, since each application will tend to have its own power requirements in terms of required voltages and currents as well as space. Redesigning the assembly for each application can add considerably to the cost of each implementation.

### SUMMARY

In accordance with the present disclosure, there is provided a fuel cell assembly comprising:

an enclosure for mounting a fuel cell stack therein, the enclosure comprising an air flow path extending between an air inlet and an air outlet; and

a fuel cell stack having a plurality of cathode air coolant paths extending between a first face and an opposing second face of the stack,

wherein the fuel cell stack is mounted within the enclosure to provide a tapering air volume between the first face of the stack and a first side wall of the enclosure and between the second face of the stack and a second opposing side wall of the enclosure.

An advantage of the fuel cell assembly according to implementations of the present disclosure is that, because tapering air volumes are provided by the relative arrangement of the enclosure and the faces of the stack, specially designed manifolds are not required, thereby reducing the complexity and cost of the overall assembly.

Diagonally opposing edges of the stack can be sealed against the respective first and second opposing side walls of the enclosure, to allow for a sealed air flow path through the enclosure.

The enclosure may comprise an inlet air filter at a first end of the air flow path and an air exhaust at a second opposing end. This helps to reduce the overall height and width of the assembly. A reducing tapered section may be incorporated, extending from the inlet air filter to the first tapered air volume, to improve uniformity of air flow to the stack.

An increasing tapered section may also be provided extending from the second tapered air volume to the air exhaust, so as to improve air flow and reduce any pressure drop across the assembly.

A fan may be provided at the air exhaust for drawing air through the air flow path. A fan may be provided at the air inlet for blowing air through the air flow path.

The enclosure may have a substantially cuboid external shape, which allows multiple assemblies to be stacked on top of one another, for increasing the power available from the stacks.

The fuel cell stack may be mounted within the enclosure at an angle of between 5 and 45 degrees to a longitudinal axis of the enclosure. This range of angles allows for air flow to be uniformly distributed along the stack, while keeping the additional height required for the enclosure to a minimum. A particular angle is around 8.5 degrees.

The fuel cell stack may comprise a staggered array of planar fuel cells between opposing end plates laterally offset from one another. The stack may be substantially cuboid in shape, with the end plates in line with each other and the stack having a uniform cross-section between the end plates.

The fuel cell stack may have a cross-sectional shape in the form of a parallelogram

A modular fuel cell assembly may be constructed from a plurality of the fuel cell assemblies according to the present disclosure, with the assemblies arranged in a regular array. The regular array may be a rectangular array.

A method of causing air to travel along an air flow path extending between an air inlet and an air outlet of a fuel cell assembly is disclosed. The method may comprise causing the air to travel through a reducing tapered inlet manifold; causing the air to travel through a first tapering air volume; and causing the air to travel through a plurality of cathode air coolant paths of a fuel cell stack. The method may further comprise: causing the air to travel through a second tapering air volume; and causing the air to travel through an increasing tapered inlet manifold. The air may be caused to travel along the air flow path by fans disposed at the air inlet or the air outlet.

### DRAWINGS

The above-mentioned features and objects of the present disclosure will become more apparent with reference to the following description taken in conjunction with the accompanying drawings wherein like reference numerals denote like elements and in which:

FIG. 1a is a cross-sectional view of an enclosure with a fuel cell stack mounted therein, according to implementations of the present disclosure;

FIG. 1b is a plan view of the enclosure of FIG. 1a, according to implementations of the present disclosure;

FIG. 2 is a cut-away perspective view of an enclosure with a fuel cell stack mounted therein, according to implementations of the present disclosure;

FIG. 3 is a perspective view of the enclosure of FIG. 2, according to implementations of the present disclosure;

FIG. 4 is a perspective view of a modular assembly of enclosures containing fuel cell stacks, according to implementations of the present disclosure;

FIG. 5 is a perspective view of a fuel cell stack, according to implementations of the present disclosure;

FIG. 6 is a cross-sectional view of the fuel cell stack of FIG. 5 mounted between opposing side walls of an enclosure, according to implementations of the present disclosure;

FIG. 7 is a perspective partially transparent view of a fuel cell assembly, according to implementations of the present disclosure;

FIG. 8 is a cross-sectional view of a fuel cell assembly, according to implementations of the present disclosure; and

FIG. 9 is an end elevation view of a fuel cell assembly, according to implementations of the present disclosure.

### DETAILED DESCRIPTION

In the following detailed description of implementations of the present disclosure, reference is made to the accompanying drawings in which like references indicate similar elements, and in which is shown by way of illustration specific implementations in which the present disclosure may be practiced. These implementations are described in sufficient detail to enable those skilled in the art to practice the present disclosure, and it is to be understood that other implementations may be utilized and that logical, mechanical, electrical, functional, and other changes may be made without departing from the scope of the present disclosure. The following detailed description is, therefore, not to be taken in a limiting sense, and the scope of the present disclosure is defined only by the appended claims. As used in the present disclosure, the term “or” shall be understood to be defined as a logical disjunction and shall not indicate an exclusive disjunction unless expressly indicated as such or notated as “xor.”

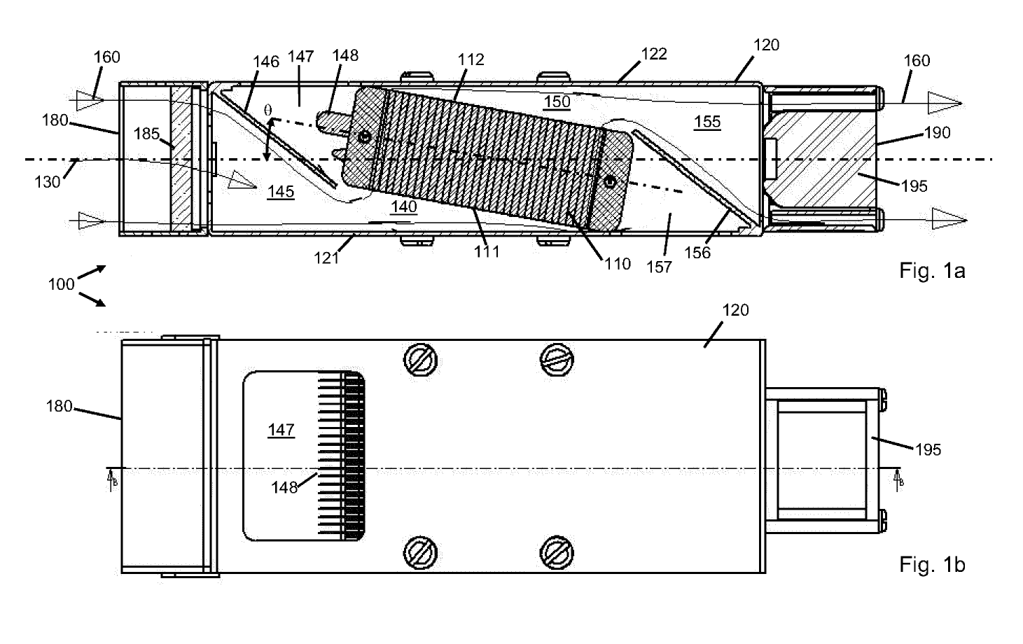

Shown in FIG. 1a is a cross-sectional view of a fuel cell assembly 100, according to implementations of the present disclosure, comprising a fuel cell stack 110 mounted within an enclosure 120. According to implementations, the stack 110 is mounted at an angle θ of between 5 and 45 degrees to the longitudinal axis 130 of the enclosure 120. According to implementations, a particular angle is around 8.5 degrees. This mounting arrangement results in a first tapered air volume 140 between a first face 111 of the stack 110 and a first wall 121 of the enclosure, and a second tapered air volume 150 between a second face 112 of the stack 110 and a second wall 122 of the enclosure 120. The first and second tapered air volumes 140, 150 form part of an air flow path 160 between an air inlet 180 and an air exhaust 190 of the enclosure 120. A reducing tapered inlet manifold 145 extends between the air inlet 180 and the first tapered air volume 140. An air filter 185 may be provided at the air inlet 180, as shown in FIG. 1a. An increasing tapered outlet manifold 155 extends between the second tapered air volume 150 and the air exhaust 190. A fan 195 may be provided at the air exhaust 190, as shown in FIG. 1a, or at the air inlet 180 to blow air through the enclosure 120.

According to implementations, the enclosure 120 may additionally provide part of the structure of the stack 110, for example taking the place of tie bolts that would otherwise be provided to clamp the end plates in position.

According to implementations, the tapered air volumes 140, 150 on either side of the stack 110 act to reduce the pressure drop in the air flow path leading through the stack and improve the distribution of air in the fuel cells making up the stack 110.

According to implementations, cover plates 146, 156 may be provided in the enclosure 120 to form tapering inlet and outlet manifolds 145, 155 leading to and from the stack 110. The cover plates may be planar, as shown in FIG. 1a, or may be curved to form a desired shape of air flow path leading to and away from the stack 110. The cover plates 146, 156 may be sealed against diagonally opposing edges of the stack 110 and against the internal faces of the enclosure 120, in order to prevent leakage of air from the air flow path 160. One or both of the cover plates 146, 156 may be formed as part of the cross-sectional shape of the enclosure 120. Further internal volumes 147, 157 provided by the cover plates 146, 156 could be used to contain other components of the fuel cell assembly, for example relating to electrical connections, and/or regulation of the fuel supply, to the stack 110. Internal volume 147 is additionally shown in FIG. 1b, according to implementations of the present disclosure, beneath an opening in a face of the enclosure 120 provided to allow access to connections 148 on the fuel cell stack 110.

According to implementations, air, which for an open cathode stack acts as both coolant and oxidant, travels along the air flow path 160. Air enters the enclosure 120 through air inlet 180 and into the tapered inlet manifold 145 before entering the first tapered air volume 140 leading to a first face 111 of the stack 110. The air passes through the stack 110 and into the second tapered volume 150 above the stack. The air then passes through the outlet manifold 155 and is drawn out of the enclosure through the air exhaust 190.

At least in relation to open cathode air-cooled fuel cell stacks, the layout shown in FIGS. 1a and 1b allows for the total height and the overall volume of the fuel cell assembly to be reduced and allows for a more rugged package with a minimum number of components. Selection of the angle of the fuel cell stack 110 to the longitudinal axis of the enclosure allows for optimization of the space used within the enclosure, both in terms of the inlet and outlet manifolds and the space required for other components.

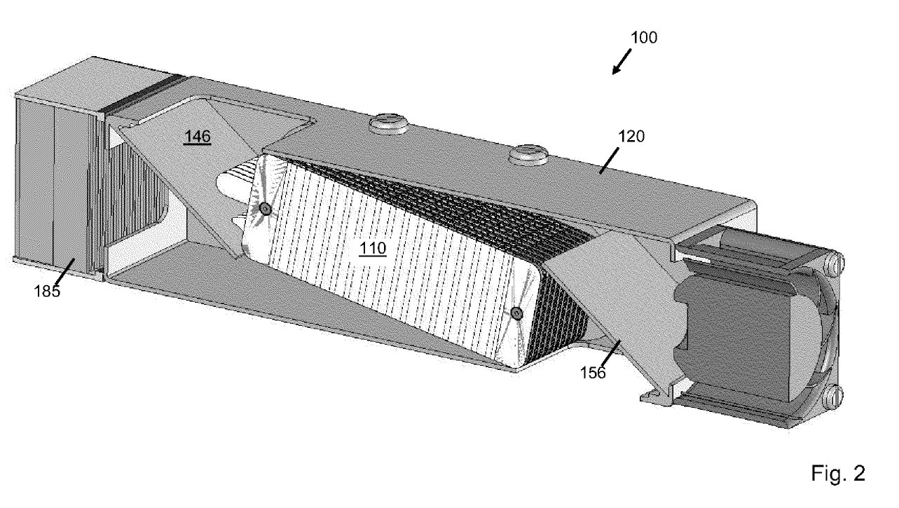

FIG. 2 shows a perspective cutaway view of the fuel cell stack 110 and enclosure 120, according to implementations of the present disclosure, illustrating the cover plates 146, 156 forming the inlet and outlet manifolds 145, 155 and further volumes 147, 157.

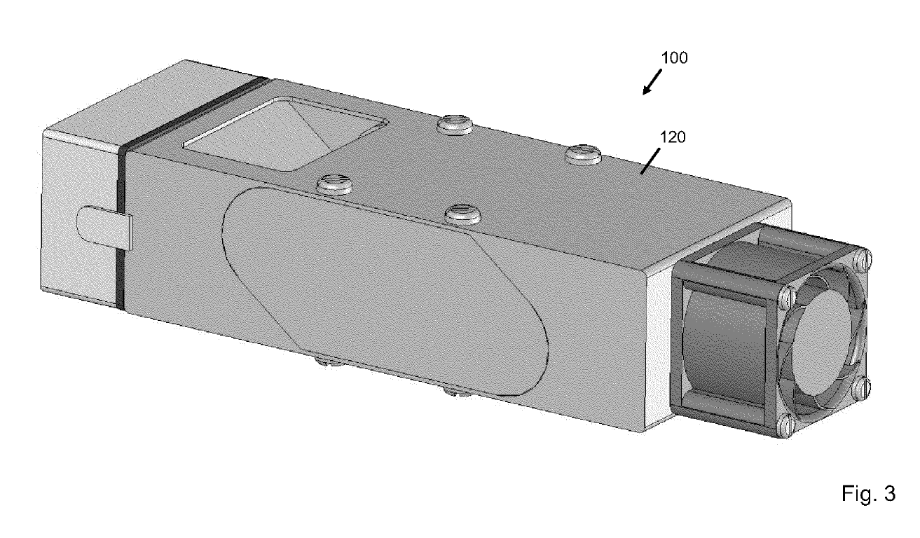

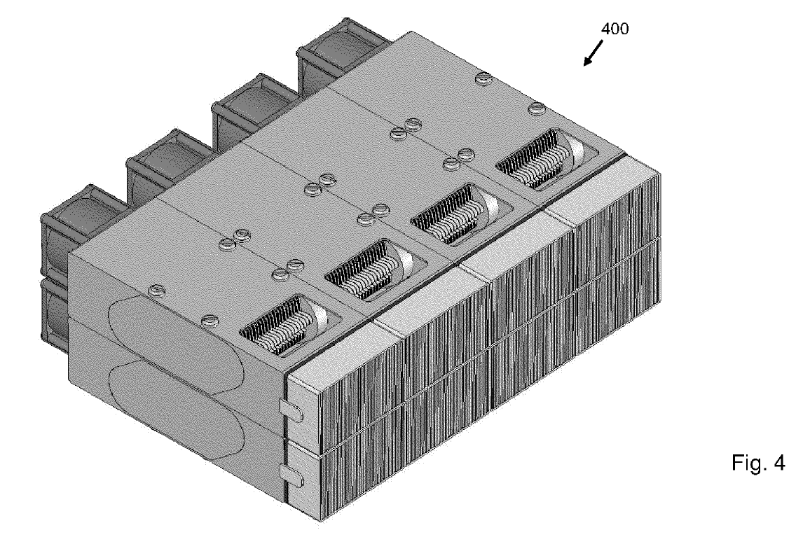

FIG. 3 shows a perspective view of the assembled enclosure 120, according to implementations of the present disclosure. The regular cuboid shape of the enclosure, in combination with the air inlet and outlet being provided at opposing ends of the enclosure 120, allows the fuel cell assembly to be provided in a modular form, i.e. with a plurality of fuel cell modules connected together physically and electrically. An exemplary arrangement of this is shown in the perspective view of FIG. 4, illustrating a rectangular array 400 of eight such modules. An advantage of such an array 400 is that manufacturing costs can be minimised across a range of applications requiring different levels of electrical power.

Although implementations of the present disclosure are particularly suitable for open cathode air-cooled designs of fuel cell stacks, other fuel cell stacks where air flow through the stack is an important feature may be incorporated into an enclosure of the type described herein.

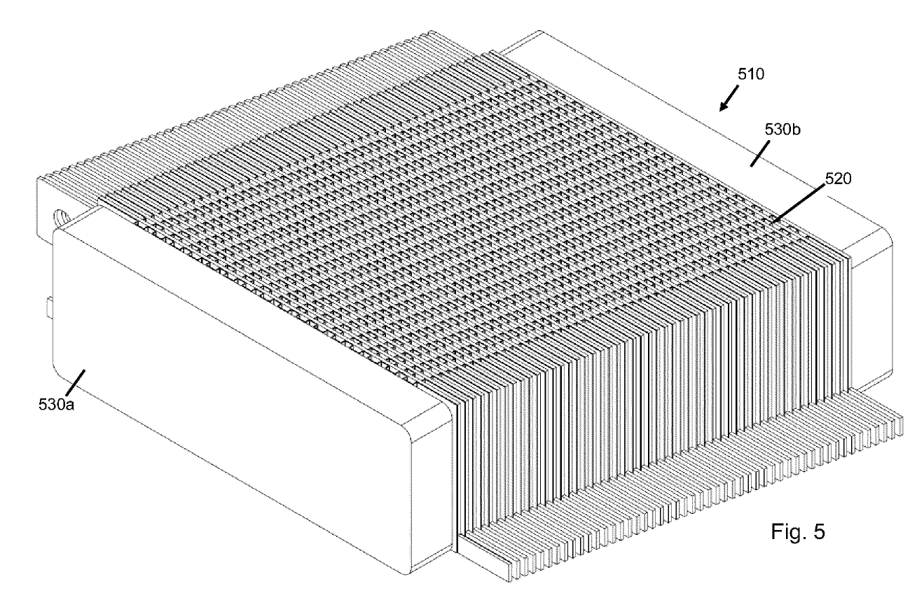

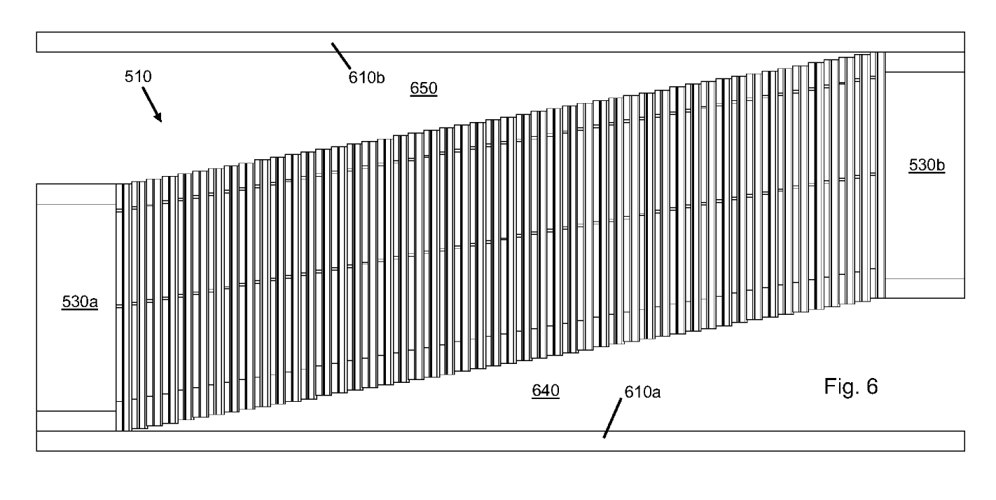

Shown in FIG. 5 is an arrangement of a fuel cell stack 510 suitable for use in implementations of the present disclosure. The stack 510 comprises a staggered array of fuel cells 520, with opposing parallel end plates 530a, 530b laterally offset from one another. The arrangement shown can thereby be mounted within an enclosure with the end plates 530a, 530b arranged orthogonally to opposing faces of the enclosure. The arrangement is shown in cross-sectional view in FIG. 6, with the end plates 530a, 530b shown in relation to side walls 610a, 610b of the enclosure, with tapered air volumes 640, 650 provided between the stack 510 and side walls 610a, 610b. Other components making up a fuel cell assembly with the arrangement shown in FIGS. 5 and 6 may be similar to those illustrated in FIGS. 1 a to 4.

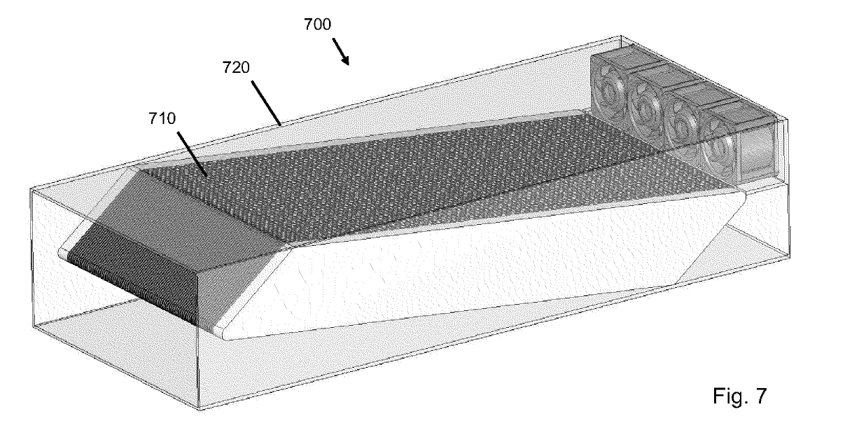

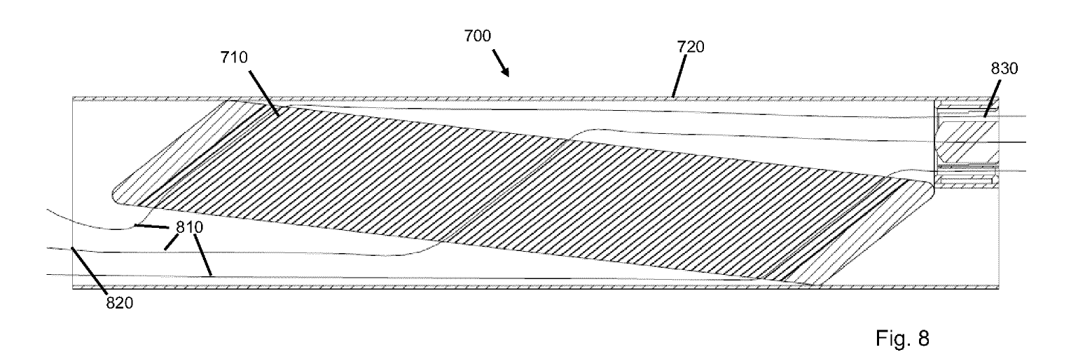

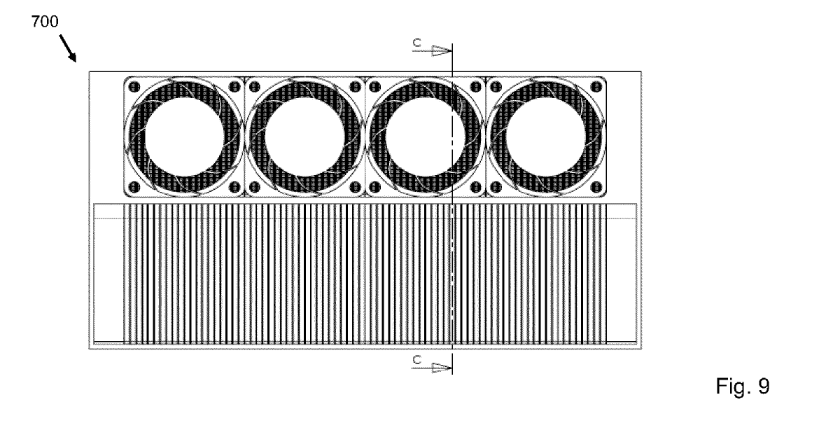

FIG. 7 shows an implementation of a fuel cell assembly 700 according to the present disclosure, in which the fuel cell stack 710 has a cross-sectional shape in the form of a parallelogram, rather than the rectangular forms shown in FIGS. 1a and 2. FIG. 8 shows a cross-sectional view through the fuel cell stack 710, according to implementations of the present disclosure, in which the alignment of each of the individual fuel cell plates can be seen. The parallelogram form of the stack 710 allows the plates to be aligned towards the air flow direction through the enclosure, indicated by air flow paths 810, thereby aiming to reduce turbulence and pressure drop between the inlet 820 and outlet 830 of the enclosure 720. An outlet end elevation view of the fuel cell assembly 700 is shown in FIG. 9, indicating the section (C-C) through which FIG. 8 is taken.

Other implementations are intentionally within the scope of the present disclosure as defined by the appended claims.

While the apparatus and method have been described in terms of what are presently considered to be the most practical and preferred implementations, it is to be understood that the disclosure need not be limited to the disclosed implementations. It is intended to cover various modifications and similar arrangements included within the spirit and scope of the claims, the scope of which should be accorded the broadest interpretation so as to encompass all such modifications and similar structures. The present disclosure includes any and all implementations of the following claims.

1. A fuel cell assembly comprising:
an enclosure for mounting a fuel cell stack therein, the enclosure comprising an air flow path extending between an air inlet and an air outlet; and
a fuel cell stack having a plurality of cathode air coolant paths extending between a first face and an opposing second face of the stack,
wherein the fuel cell stack is mounted within the enclosure to provide a first tapering air volume between the first face of the stack and a first side wall of the enclosure and a second tapering air volume between the second face of the stack and a second opposing side wall of the enclosure.

2. The fuel cell assembly of claim 1, wherein diagonally opposing edges of the stack are sealed against the respective first and second opposing side walls of the enclosure.

3. The fuel cell assembly of claim 1, wherein the enclosure comprises an inlet air filter at a first end of the air flow path and an air exhaust at a second opposing end.

4. The fuel cell assembly of claim 3, further comprising a reducing tapered section extending from the inlet air filter to the first tapered air volume.

5. The fuel cell assembly of claim 3, further comprising a increasing tapered section extending from the second tapered air volume to the air exhaust.

6. The fuel cell assembly of claim 3, further comprising a fan provided at the air exhaust for drawing air through the air flow path.

7. The fuel cell assembly of claim 1, wherein the enclosure has a substantially cuboid external shape.

8. The fuel cell assembly of claim 1, wherein the fuel cell stack is mounted at an angle of between 5 and 45 degrees to a longitudinal axis of the enclosure.

9. The fuel cell assembly of claim 1, wherein the fuel cell stack comprises a staggered array of planar fuel cells between opposing end plates laterally offset from one another.

10. The fuel cell assembly of claim 1, wherein the fuel cell stack has a cross-sectional shape in the form of a parallelogram.

11. A method of causing air to travel along an air flow path extending between an air inlet and an air outlet of a fuel cell assembly, comprising:
causing the air to travel through a reducing tapered inlet manifold;
causing the air to travel through a first tapering air volume; and
causing the air to travel through a plurality of cathode air coolant paths of a fuel cell stack.

12. The method of claim 11, further comprising:
causing the air to travel through a second tapering air volume; and
causing the air to travel through an increasing tapered inlet manifold.

13. The method of claim 11, wherein causing the air to travel along the air flow path is effectuated by fans disposed at the air inlet.

14. The method of claim 11, wherein causing the air to travel along the air flow path is effectuated by fans disposed at the air outlet.
